(19) United States
(12) Patent Application Publication
(10) Pub. No.: US 2026/0176156 A1
(43) Pub. Date: Jun. 25, 2026

(54) Precursor for Positive Electrode Active Material, Method for Producing the Precursor, and Positive Electrode Active Material, Positive Electrode and Lithium Secondary Battery Using the Precursor

(71) Applicant: LG Energy Solution, Ltd., Seoul (KR)

(72) Inventors: Chang Hwan Kim, Daejeon (KR); Tae Gu Yoo, Daejeon (KR); Chi Ho Jo, Daejeon (KR); Jin Bum Park, Daejeon (KR); Ji Young Ju, Daejeon (KR); Hee Jin Noh, Daejeon (KR); Yong Seok Lee, Daejeon (KR)

(73) Assignee: LG Energy Solution, Ltd., Seoul (KR)

(21) Appl. No.: 19/425,176

(22) Filed: Dec. 18, 2025

(30) Foreign Application Priority Data
Dec. 24, 2024 (KR) 10-2024-019666

(51) Int. Cl. C01G 53/504; H01M 10/052

(52) U.S. Cl. CPC C01G 53/504; H01M 10/052; C01P 2002/72; C01P 2004/50; C01P 2006/40

(57) ABSTRACT

A precursor for a positive electrode active material has a composition represented by Liₐ[Ni_{b}Co_{c}Mn_{d}M1ₑ]O_{f}, in which a ratio of a sum of areas of peaks representing Li₂CO₃ to a sum of areas of all peaks in an XRD spectrum obtained by performing X-ray diffraction analysis on the precursor is about 0.01 to 0.15, and to a method for producing the precursor.

### CROSS-REFERENCE TO RELATED APPLICATIONS

This application is based on and claims priority from Korean Patent Application No. 10-2024-0196366 filed on Dec. 24, 2024, with the Korean Intellectual Property Office, the disclosure of which is incorporated herein in its entirety by reference.

### TECHNICAL FIELD

The present disclosure relates to a precursor for a positive electrode active material, a method for producing the precursor, a positive electrode active material, and a positive electrode and a lithium secondary battery including the positive electrode active material.

### BACKGROUND

The use of secondary batteries has been steadily growing, driven by the expansion of demand sources such as electric vehicles (EVs) and energy storage systems (ESSs). Accordingly, efforts are also being continuously made to improve the performance and safety of secondary batteries.

A secondary battery generally includes four core components: a positive electrode, a negative electrode, a separator, and an electrolyte, and these components organically interact with one another to store and release energy while repeatedly undergoing charging and discharging. For example, during charging and discharging, lithium ions move between the positive electrode and the negative electrode through the electrolyte, thereby generating electricity, and the positive electrode and the negative electrode determine the performance of the battery, while the electrolyte and the separator determine the safety of the secondary battery.

### SUMMARY

The present disclosure provides a precursor for a positive electrode active material and a method for producing the precursor, which enable the manufacture of a positive electrode active material having excellent low-temperature resistance characteristics by satisfying specific conditions for the area of a peak representing Li₂CO₃ in an X-ray diffraction spectrum.

In addition, the present disclosure provides a positive electrode active material using the precursor for a positive electrode active material, and a positive electrode and a lithium secondary battery including the positive electrode active material.
[1] The present disclosure provides a precursor for a positive electrode active material having a composition represented by Formula 1 below, in which a ratio of a sum of areas of peaks representing Li₂CO₃ to a sum of areas of all peaks appearing in an XRD spectrum obtained by performing X-ray diffraction analysis on the precursor ranges from about 0.01 to 0.15.

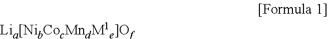

In Formula 1, M¹ includes one or more elements selected from Al, Zr, Y, W, Nb, Ti, Ba, and Sr, and a, b, c, d, e, and f satisfy 1<a≤1.08, 0.5≤b<1, 0<c<0.5, 0<d<0.5, 0≤e≤0.2, and 2≤f≤2.06.
[2] The present disclosure provides the precursor for a positive electrode active material according to [1], in which the peaks representing Li₂CO₃ in the XRD spectrum appear in regions where the 2-theta (0) values are about 21.3°, 23.5°, 30.4°, 31.7°, 34.0°, and 39.8°.
[3] The present disclosure provides the precursor for a positive electrode active material according to [1] or [2], in which, in Formula 1, a, b, c, and d satisfy 1.02≤a≤1.06, 0.5b≤0.8, 0.05≤c<0.5, and 05≤d<0.5.
[4] The present disclosure provides the precursor for a positive electrode active material according to at least one of [1] to [3], in which the precursor is produced by spray pyrolysis.
[5] The present disclosure provides a precursor for a positive electrode active material according to at least one of [1] to [4], in which the precursor is in a form of secondary particles in which a plurality of primary particles are agglomerated, and the primary particles have a polycrystalline structure.
[6] The present disclosure provides the precursor for a positive electrode active material according to at least one of [1] to [5], in which the precursor has a hollow structure.
[7] The present disclosure provides a method for producing a precursor for a positive electrode active material, the method including: forming a reaction mixture by mixing a lithium source, a nickel source, a cobalt source, a manganese source, and a solvent; and spraying the reaction mixture into a high-temperature reactor followed by pyrolysis to form the precursor for a positive electrode active material, in which a molar ratio of lithium to transition metal in the reaction mixture is about 1:1 to 1.08:1.
[8] The present disclosure provides the method for producing a precursor for a positive electrode active material according to [7], in which the lithium source is lithium metal, lithium carbonate, lithium hydroxide, lithium acetate, lithium oxalate, lithium sulfate, lithium chloride, lithium nitrate, or a combination thereof.
[9] The present disclosure provides the method for producing a precursor for a positive electrode active material according to [7] or [8], in which the nickel source is nickel metal, nickel carbonate, nickel hydroxide, nickel acetate, nickel sulfate, nickel chloride, nickel nitrate, nickel pig iron (NPI), mixed hydroxide precipitate (Ni MHP), or a combination thereof.
[10] The present disclosure provides the method for producing a precursor for a positive electrode active material according to at least one of [7] to [9], in which the cobalt source is cobalt metal, cobalt carbonate, cobalt hydroxide, cobalt acetate, cobalt sulfate, cobalt chloride, cobalt nitrate, mixed hydroxide precipitate (Co MHP), or a combination thereof.
[11] The present disclosure provides the method for producing a precursor for a positive electrode active material according to at least one of [7] to [10], in which the manganese source is manganese metal, aluminum metal, manganese carbonate, manganese hydroxide, manganese acetate, manganese sulfate, manganese chloride, manganese nitrate, mixed hydroxide precipitate (Mn MHP), or a combination thereof.
[12] The present disclosure provides the method for producing a precursor for a positive electrode active material according to at least one of [7] to [11], in which the solvent is sulfuric acid, nitric acid, acetic acid, carbonic acid, or a combination thereof.
[13] The present disclosure provides the method for producing a precursor for a positive electrode active material according to at least one of [7] to [12], in which the pyrolysis is performed at a temperature ranging from about 600° C. to 900° C.
[14] The present disclosure provides a positive electrode active material including a calcined body of the precursor for a positive electrode active material according to at least one of [1] to [6].
[15] The present disclosure provides the positive electrode active material according to [14], in which the positive electrode active material includes a lithium-nickel-based oxide having a composition represented by Formula 2:

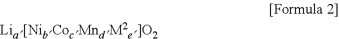

In Formula 2, M² includes one or more elements selected from Al, Zr, Y, W, Nb, Ti, Ba, and Sr, and a′, b′, c′, d′, and e′ satisfy 0.8≤a′≤1.08, 0.5≤b′<1, 0<c′<0.5, 0<d′<0.5, and 0≤e′≤0.2.
[16] The present disclosure provides the positive electrode active material according to [14] or [15], in which the positive electrode active material includes a single-particle-type lithium-nickel-based oxide including 50 nodules or fewer.
[17] The present disclosure provides a positive electrode including the positive electrode active material according to at least one of [14] to [16].
[18] The present disclosure provides a lithium secondary battery including the positive electrode according to [17], a negative electrode, and an electrolyte.

The precursor for a positive electrode active material according to the present disclosure satisfies a ratio of a sum of areas of lithium carbonate peaks to a sum of areas of all peaks in an XRD spectrum in a range of about 0.01 to 0.15. When the XRD peak characteristics of the precursor satisfy the above condition, the low-temperature resistance characteristics of the positive electrode active material produced by calcining the precursor may be improved. The low-temperature resistance characteristics of the positive electrode active material vary depending on the lithium carbonate ratio in the precursor. For example, lithium carbonate present in the precursor acts as a lithium source during a calcination process, increasing a lithium ratio relative to transition metals, thereby reducing a cation mixing ratio and consequently improving resistance.

The precursor for a positive electrode active material according to the present disclosure may be produced by spray pyrolysis. When the precursor is produced by spray pyrolysis, the process is simpler than a coprecipitation method mainly used in the related art, and the producing time is shorter, thereby increasing the production yield per unit time and reducing the production cost of the precursor.

According to an embodiment of the present disclosure, the method for producing a precursor for a positive electrode active material includes mixing a lithium source and a transition metal source together when preparing a reaction mixture, and producing the precursor by spray pyrolysis. Because the precursor produced by the above method is formed in the form of a lithium metal oxide, unlike in the related art in which a precursor and a lithium source were mixed and then calcined, the precursor itself may be calcined to manufacture a positive electrode active material, thereby simplifying the process. In addition, according to the method of the present disclosure, since a long coprecipitation reaction is not required, the time required to manufacture the precursor may be reduced.

The method for producing a precursor according to the present disclosure enables the manufacture of a precursor that satisfies a ratio of a sum of areas of lithium carbonate (Li₂CO₃) peaks to a sum of areas of all peaks in an XRD spectrum of a precursor of a positive electrode active material (Liₐ[Ni_{b}Co_{c}Mn_{d}M¹ₑ]O_{f}) in a range of about 0.01 to 0.15, by allowing a lithium-to-transition-metal molar ratio in a reaction mixture to satisfy a specific range.

A precursor that satisfies a ratio of a sum of areas of lithium carbonate (Li₂CO₃) peaks to a sum of areas of all peaks in an XRD spectrum of the precursor for a positive electrode active material represented by Liₐ[Ni_{b}Co_{c}Mn_{d}M¹ₑ]O_{f} in a range of about 0.01 to 0.15 is calcined to manufacture a positive electrode active material. The positive electrode active material produced by using a precursor as described above exhibits excellent lithium-ion mobility at low temperatures. Accordingly, when the precursor is applied, a lithium secondary battery having excellent low-temperature resistance characteristics may be manufactured.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 illustrates a method for producing a precursor for a positive electrode active material according to an embodiment of the present disclosure.

FIG. 2 is a view illustrating a structure of a positive electrode manufactured using a precursor for a positive electrode active material according to an embodiment of the present disclosure.

FIG. 3 is a view illustrating a structure of a secondary battery manufactured by applying a positive electrode manufactured using a precursor for a positive electrode active material according to an embodiment of the present disclosure.

FIG. 4 illustrates an XRD spectrum of a precursor prepared in Example 2.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments.

Also, common but well-understood elements that are useful or necessary in a commercially feasible embodiment are often not depicted in order to facilitate a less obstructed view of these various embodiments.

### DETAILED DESCRIPTION

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain his or her own invention in the best way.

In the present disclosure, when a part is described as “including” a certain component, this means that, unless specified otherwise, the part does not exclude the presence of other components but may further include additional components.

In the present disclosure, the term “single-particle-type” refers to a particle composed of 50 or fewer nodules and refers to a concept including a single particle composed of one nodule and a quasi-single particle, which is a composite of two to fifty nodules.

The term “nodule” refers to a sub-particle unit constituting a single particle or a quasi-single particle, which may be either a single crystal having no crystalline grain boundary or a polycrystal in which grain boundaries are not visually observed at a magnification of about 5,000× to 20,000× using a scanning electron microscope.

In the present disclosure, the term “secondary particle” refers to a particle formed by aggregation of a plurality of primary particles, for example, several tens to several hundreds of primary particles. For example, a secondary particle may be an aggregate of more than 50 primary particles.

In the present disclosure, the term “particle” is a concept including any one or all of a single particle, a quasi-single particle, a primary particle, a nodule, and a secondary particle.

In the present disclosure, an average particle diameter (Dmean) of nodules or primary particles refers to an arithmetic average value calculated after measuring the particle diameters of nodules or primary particles observed in an image obtained by a scanning electron microscope.

In the present disclosure, the term “average particle diameter D50” refers to a particle size corresponding to 50% of the cumulative volume in a volume cumulative particle size distribution of the powder to be measured, and may be measured using a laser diffraction method. For example, after dispersing the powder to be measured in a dispersion medium, the dispersed sample may be introduced into a commercially available laser diffraction particle size analyzer (e.g., Microtrac MT 3000), and irradiated with ultrasonic waves at about 28 kHz with an output of 60 W. Then, a volume cumulative particle size distribution graph is obtained, and the particle size corresponding to 50% of the cumulative volume is determined, thereby measuring the average particle diameter D₅₀.

As used herein, the terms “about,” “approximately,” and “substantially” are used to mean a range of the numerical value or degree, or a value close thereto, in consideration of inherent manufacturing and material tolerances (e.g., ±5%).

In view of the performance of a lithium secondary battery from two aspects, the positive electrode mainly includes a lithium oxide and determines the capacity and performance of the battery, while the negative electrode mainly includes graphite and greatly influences the lifespan of the battery. Meanwhile, the positive electrode and the negative electrode of a lithium secondary battery are manufactured by using a positive electrode active material and a negative electrode active material, respectively.

When producing a precursor for a positive electrode active material, a method of introducing a metal solution containing transition metal elements, an alkaline aqueous solution, and a chelating agent into a reactor and performing a coprecipitation reaction has mainly been used. In the case of the coprecipitation method, which has mainly been used for precursor synthesis, a long time is required for precursor particle growth, and post-processes such as filtration, drying, and washing should be performed after the coprecipitation reaction. In addition, in order to manufacture a positive electrode active material, calcination had to be carried out after mixing a precursor and a lithium source. When a positive electrode active material is produced through the coprecipitation method as described above, multiple complicated process steps should be performed, and energy consumption is high, resulting in high manufacturing costs.

Recently, methods of synthesizing a precursor for a positive electrode active material using spray pyrolysis have been attempted. Spray pyrolysis is a method of producing particles by spraying a solution in which a precursor is dissolved into droplets having sizes from several micrometers to several tens of micrometers and then evaporating the solvent by applying heat. When a precursor for a positive electrode active material is produced by spray pyrolysis, post-processes such as filtration and washing may not be required, the producing time may be reduced, and a precursor may be produced at a relatively lower cost compared to the coprecipitation method.

However, the precursor produced by spray pyrolysis is more difficult to control in particle morphology and particle size distribution compared to the precursor produced by the coprecipitation method. Therefore, when a positive electrode active material is produced using the precursor, there has been a problem in that the physical properties such as resistance, capacity, and lifespan are inferior to those of a positive electrode active material produced using a precursor produced by the coprecipitation method.

In view of these issues, the present disclosure provides a precursor that allows a positive electrode active material having excellent physical properties to be produced with a low manufacturing cost and through a simple process.

Hereinafter, the present disclosure will be described in detail.

The precursor for a positive electrode active material, the method for producing the precursor for a positive electrode active material, the positive electrode active material, the positive electrode, and/or the lithium secondary battery according to the present disclosure may include at least one of the configurations disclosed below, and may include any technically feasible combination among the configurations described below.

### Precursor for Positive Electrode Active Material

First, the precursor for a positive electrode active material according to the present disclosure will be described.

The precursor for a positive electrode active material according to the present disclosure is a lithium metal oxide having a composition represented by Formula 1:

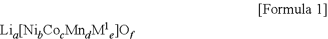

In Formula 1, M¹ may include one or more elements selected from Al, Zr, Y, W, Nb, Ti, Ba, and Sr, and according to an embodiment, may include one or more elements selected from Zr, Y, W, Al, and Sr. When the element M¹ is included, improved effects may be obtained in terms of high-temperature lifespan, resistance, and/or gas generation.

The symbol “a” represents a molar ratio of lithium to a total number of moles of metals excluding lithium in the precursor, and may satisfy 1<a≤1.08, 1.01≤a≤1.07, or 1.02≤a≤1.06. When a positive electrode active material is produced by using a precursor in which “a” satisfies the above range, a layered structure is well formed, and exhibits excellent lithium-ion mobility. In order for the layered structure to be well formed, a lithium-to-transition-metal molar ratio needs to be at a level of 1:1. However, lithium loss occurs in the calcination process for producing a positive electrode active material. According to the present disclosure, a positive electrode active material having excellent lithium-ion mobility may be produced by allowing the ratio “a,” which is a molar ratio of lithium to a total number of moles of transition metals in the precursor, to exceed 1. Meanwhile, by preventing the molar ratio of lithium to the total number of moles of transition metals from exceeding 1.08 and appropriately controlling the remaining lithium amount, a positive electrode active material having excellent capacity, low-temperature resistance, and gas-generation characteristics may be produced.

The symbol “b” represents a molar ratio of Ni among the metals excluding lithium in the precursor, and may satisfy 0.5≤b<1, 0.5≤b≤0.8, or 0.5≤b≤0.75.

The symbol “c” represents a molar ratio of Co among the metals excluding lithium in the precursor, and may satisfy 0<c<0.5, 0.05≤c<0.5, or 0.05≤c≤0.3.

The symbol “d” represents a molar ratio of Mn among the metals excluding lithium in the precursor, and may satisfy 0<d<0.5, 0.05≤d<0.5, or 0.1≤d≤0.4.

The symbol “e” represents a molar ratio of an M¹ element among the metals excluding lithium in the precursor, and may satisfy 0≤e≤0.2, 0≤e≤0.15, or 0≤e≤0.10.

The symbol “f” represents a molar ratio of oxygen to a total number of moles of the metals excluding lithium in the precursor, and may satisfy 2≤f≤2.06, 2≤f≤2.04, or 2≤f≤2.2.

Unlike a hydroxide-type precursor produced through a coprecipitation reaction, the precursor according to the present disclosure, which is in the form of a lithium metal oxide, contains lithium within the precursor. Therefore, without mixing an additional lithium source, a positive electrode active material may be produced by calcining the precursor. Accordingly, compared to conventional processes, a positive electrode active material may be produced through a simpler process. In addition, the precursor according to the present disclosure, which does not require washing and drying processes that are required for hydroxide-type precursors, further provides an advantage in that no wastewater treatment is required.

When synthesizing a precursor having the composition represented by Chemical Formula 1, lithium introduced into the reaction mainly forms lithium metal oxides by being combined with metals such as Ni, Co, and Mn, but some lithium may also be present in the form of Li₂CO₃ formed by being combined with anions.

The present disclosure is based on the finding that the ratio of Li₂CO₃ present in the precursor of a positive electrode active material affects the low-temperature resistance characteristics of the finally formed positive electrode active material.

As the content of Li₂CO₃ in the precursor increases, the peaks representing Li₂CO₃ appear more strongly in an XRD spectrum. Accordingly, a ratio (A_{Li}_{₂}_{CO}_{₃}/Aₜₒₜₐₗ), which is a ratio of a sum of areas of peaks representing Li₂CO₃ (A_{Li}_{₂}_{CO}_{₃}) to a sum of areas of all peaks (Aₜₒₜₐₗ) appearing in an XRD spectrum, may be used as a parameter representing the proportion of Li₂CO₃ in the precursor. Here, the peaks representing Li₂CO₃ are those appearing in regions where 2-theta (θ) values are about 21.3°, 23.5°, 30.4°, 31.7°, 34.0°, and 39.8°.

According to an embodiment of the present disclosure, when the ratio (A_{Li}_{₂}_{CO}_{₃}/Aₜₒₜₐₗ) of a sum of areas of peaks representing Li₂CO₃ (A_{Li}_{₂}_{CO}_{₃}) to a sum of areas of all peaks (Aₜₒₜₐₗ) appearing in an XRD spectrum obtained by performing X-ray diffraction analysis on a precursor for a positive electrode active material satisfies about 0.01 to 0.15, the positive electrode active material exhibited excellent low-temperature resistance characteristics. For example, the ratio A_{Li}_{₂}_{CO}_{₃}/Aₜₒₜₐₗ may range from about 0.01 to 0.12, or from about 0.01 to 0.1.

The precursor for a positive electrode active material according to the present disclosure may be in the form of secondary particles in which a plurality of primary particles are agglomerated, and in this case, the primary particles may have a polycrystalline structure. In contrast to lithium-nickel-based oxides previously used as positive electrode active materials, in which most primary particles have a single-crystal structure, the lithium metal oxide of the present disclosure produced as a precursor includes primary particles having a polycrystalline structure.

In addition, the precursor for a positive electrode active material according to the present disclosure may have a hollow structure.

The precursor for a positive electrode active material according to the present disclosure has a relatively high porosity compared to lithium metal oxides conventionally used as positive electrode active materials. When the precursor has a hollow structure or has high porosity, there is an advantage in that reactivity with lithium is improved and density is reduced, thereby facilitating pulverization.

The precursor for a positive electrode active material according to the present disclosure may be produced by spray pyrolysis.

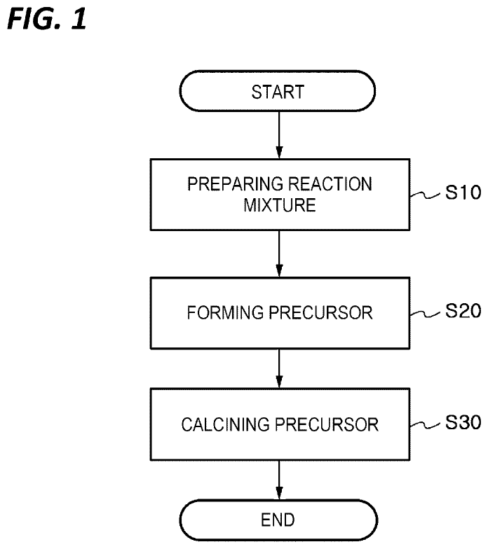

Referring to FIG. 1, the method for producing a precursor for a positive electrode active material according to the present disclosure includes: (1) preparing a reaction mixture by mixing a lithium source, a nickel source, a cobalt source, a manganese source, and a solvent (S10); and (2) spraying the reaction mixture into a high-temperature reactor followed by pyrolysis to form the precursor for a positive electrode active material (S20).

First, a reaction mixture is formed by mixing a lithium source, a nickel source, a cobalt source, a manganese source, and a solvent (S10).

The lithium source may be lithium metal, lithium carbonate, lithium hydroxide, lithium acetate, lithium oxalate, lithium sulfate, lithium chloride, lithium nitrate, or a combination thereof.

The nickel source may be nickel metal, nickel carbonate, nickel hydroxide, nickel acetate, nickel sulfate, nickel chloride, nickel nitrate, nickel pig iron (NPI), nickel mixed hydroxide precipitate (Ni MHP), or a combination thereof.

The cobalt source may be cobalt metal, cobalt carbonate, cobalt hydroxide, cobalt acetate, cobalt sulfate, cobalt chloride, cobalt nitrate, cobalt mixed hydroxide precipitate (Co MHP), or a combination thereof.

The manganese source may be manganese metal, manganese carbonate, manganese hydroxide, manganese acetate, manganese sulfate, manganese chloride, manganese nitrate, manganese mixed hydroxide precipitate (Mn MHP), or a combination thereof.

The solvent may be sulfuric acid, nitric acid, acetic acid, carbonic acid, or a combination thereof.

Meanwhile, the reaction mixture may further include an M¹ source, as needed. The M¹ source may be an M¹ metal element, a carbonate containing an M¹ element, a hydroxide, an acetate, a sulfate, a chloride, a nitrate, a mixed hydroxide precipitate (MHP), or a combination thereof.

A lithium-to-transition-metal molar ratio in the reaction mixture may range from about 1:1 to 1.08:1, for example, from about 1:1 to 1.07:1, or from about 1:1 to 1.06:1.

A Ni:Co:Mn molar ratio in the reaction mixture may be appropriately adjusted in consideration of the composition of a precursor to be produced.

The reaction mixture may be prepared by introducing a lithium source, a nickel source, a cobalt source, and a manganese source, and optionally an M¹ source, into the solvent and homogenizing them through, for example, stirring.

When the reaction mixture is prepared, the reaction mixture is supplied to a spray pyrolysis apparatus, sprayed into a high-temperature reactor, and pyrolyzed to form precursor particles (S20). The spray pyrolysis apparatus may include, for example, a nozzle configured to spray droplets and a high-temperature reactor connected to the nozzle.

The spraying may be performed through a spray nozzle provided in the spray pyrolysis apparatus.

The spraying may be performed, for example, at a pressure of about 0.01 to 0.5 MPa, 0.01 to 0.3 MPa, or 0.05 to 0.2 MPa. When the spraying pressure satisfies the above range, a particle size of the precursor may be appropriately formed, and a precursor having a hollow structure may be obtained. When the precursor is formed to have a hollow structure, a specific surface area becomes high, thereby improving reactivity with lithium and reducing density, which facilitates pulverization.

The pyrolysis may be performed at a temperature of about 600° C. to 900° C., for example, about 700° C. to 800° C. When the pyrolysis temperature satisfies the above range, a solvent in sprayed droplets is dried and moisture is evaporated, such that a precursor having a hollow structure may be easily formed.

Meanwhile, after forming the precursor, the produced precursor powder may be loaded into an XRD device, and X-ray diffraction analysis may be performed under appropriate conditions to obtain an XRD spectrum. In addition, from the XRD spectrum, a ratio (A_{Li}_{₂}_{CO}_{₃}/Aₜₒₜₐₗ), which is a ratio of a sum of areas of peaks representing Li₂CO₃ (A_{Li}_{₂}_{CO}_{₃}) to a sum of areas of all peaks (Aₜₒₜₐₗ), may be obtained.

### Positive Electrode Active Material

Next, referring back to FIG. 1, a positive electrode active material according to the present disclosure will be described.

The positive electrode active material according to the present disclosure includes a calcined body of the precursor for a positive electrode active material according to the present disclosure described above. The positive electrode active material according to the present disclosure may be produced by calcining the precursor for a positive electrode active material according to the present disclosure described above at a temperature of about 800° C. to 1,000° C. (S30). The calcination may be performed in a single step or may be performed in multiple steps. For example, the calcination may be performed once at a temperature of about 900° C. to 1,000° C., for example, about 920° C. to 980° C., or may be performed as a two-step calcination in which a first calcination is performed at a temperature of about 800° C. to 900° C. and a second calcination is performed at a temperature of about 900° C. to 1,000° C. When the calcination is performed in multiple steps, there is an advantage in that sufficient heat may be provided at a temperature at which crystallization is stably achieved, thereby increasing a primary particle size and crystallinity.

The positive electrode active material according to the present disclosure may include a lithium-nickel-based oxide.

The lithium-nickel-based oxide may have a composition represented by Formula 2:

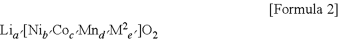

In Formula 2, M² may include one or more elements selected from Al, Zr, Y, W, Nb, Ti, Ba, and Sr.

The symbol “a′” represents a molar ratio of lithium to a total number of moles of metals excluding lithium in the lithium-nickel-based oxide, and may satisfy 0.8≤a′≤1.2, 0.9≤a′≤1.1, or 0.95≤a′≤1.1.

The symbol “b′” represents a molar ratio of Ni among the metals excluding lithium in the lithium-nickel-based oxide, and may satisfy 0.5≤b′<1, 0.5≤b′≤0.8, or 0.5≤b′≤0.75.

The symbol “c′” represents a molar ratio of Co among the metals excluding lithium in the lithium-nickel-based oxide, and may satisfy 0<c′<0.5, 0.05≤c′<0.5, or 0.05≤c′≤0.3.

The symbol “d′” represents a molar ratio of Mn among the metals excluding lithium in the lithium-nickel-based oxide, and may satisfy 0<d′<0.5, 0.05≤d′<0.5, or 0.1≤d′≤0.4.

The symbol “e′” represents a molar ratio of an M² element among the metals excluding lithium in the lithium-nickel-based oxide, and may satisfy 0≤e′≤0.2, 0≤e′ ≤0.15, or 0≤e′≤0.10.

According to an embodiment, the lithium-nickel-based oxide may be a lithium composite transition-metal oxide including nickel in an amount of about 50 mol % or more among the metals excluding lithium, for example, about 50 mol % to 80 mol %, or about 50 mol % to 70 mol %.

The form of the lithium-nickel-based oxide is not particularly limited, and according to an embodiment, may be in the form of secondary particles in each of which more than 50 primary particles are agglomerated, or may be in the form of single particles including 50 nodules or fewer. In this case, the primary particles may have a single-crystal structure. When necessary, a positive electrode active material including a secondary-particle-type lithium-nickel-based oxide and a positive electrode active material including a single-particle-type lithium-nickel-based oxide may be used in combination. A positive electrode active material including a secondary-particle-type lithium-nickel-based oxide exhibits excellent resistance and capacity characteristics, and a positive electrode active material including a single-particle-type lithium-nickel-based oxide exhibits excellent high-temperature/high-voltage stability and lifespan characteristics. Accordingly, an appropriate form of lithium-nickel-based oxide may be selected and used in consideration of, for example, performance and specifications of a lithium secondary battery to be manufactured.

According to an embodiment, the lithium-nickel-based oxide may be a single-particle-type lithium-nickel-based oxide including 50 nodules or fewer.

In the case of the single-particle-type lithium-nickel-based oxide, compared with a secondary-particle-type lithium-nickel-based oxide, particle breakage caused by rolling during the manufacture of a positive electrode is reduced, and structural stability is excellent under high-temperature and/or high-voltage conditions. Accordingly, when the single-particle-type lithium-nickel-based oxide is applied, degradation of the positive electrode under high-temperature or high-voltage conditions is reduced, and generation of fine particles after electrode manufacture is reduced, resulting in reduced gas generation caused by side reactions between the fine particles and the electrolyte. Accordingly, when a single-particle-type lithium-nickel-based oxide is applied, it is advantageous for manufacturing a lithium secondary battery having long-lifespan characteristics.

According to an embodiment, the single-particle-type lithium-nickel-based oxide may include 50 nodules or fewer, for example, about 30 nodules or fewer, about 1 to 25 nodules, or about 1 to 15 nodules. When the single-particle-type lithium-nickel-based oxide includes nodules within the above range, particle breakage during electrode manufacturing may be reduced, and internal crack formation caused by volume expansion and contraction of the nodules during charging and discharging may be reduced, thereby improving high-temperature lifespan characteristics and high-temperature storage characteristics.

According to an embodiment, the nodules may have an average particle diameter ranging from about 0.8 μm to 4.0 m, about 0.8 μm to 3 μm, or about 1.0 μm to 3.0 μm. When the average particle diameter of the nodules satisfies the above range, particle breakage during electrode manufacturing is minimized, and an increase in resistance may be more effectively suppressed. In this case, the average particle diameter of the nodules refers to a value obtained by measuring particle diameters of nodules observed in an SEM image acquired by analyzing a positive electrode active material powder using a scanning electron microscope, and calculating an arithmetic average of the measured values.

The single-particle-type lithium-nickel-based oxide may contain Ni in an amount ranging from about 50 mol % to 80 mol %, about 50 mol % to 75 mol %, or about 50 mol % to 70 mol % among the metals excluding lithium. When the single-particle-type lithium-nickel-based oxide contains Ni in an amount ranging from about 50 mol % to 80 mol %, structural stability at high voltages is high, and therefore, degradation of lifespan characteristics during high-voltage operation may be minimized. In the present disclosure, by applying a lithium-nickel-based oxide having an Ni content of about 80 mol % or less, degradation of lifespan due to active-material deterioration during high-voltage operation was suppressed. However, when the Ni content is too low, since the capacity characteristics deteriorate, the Ni content of the lithium-nickel-based oxide was maintained at about 50 mol % or more.

Meanwhile, the positive electrode active material according to the present disclosure may further include a coating layer on a surface of the lithium-nickel-based oxide. The coating layer may include one or more elements selected from Co, Al, W, Ti, Mg, Zr, Y, Ba, Ca, Sr, Ta, Nb, P, B, and Mo. When the coating layer is formed on the surface of the lithium-nickel-based oxide, effects such as improvement in surface resistance characteristics, prevention of agglomeration during preparation of a positive electrode slurry, and reduction in gas generation by decreasing the contact area with the electrolyte may be obtained. According to an embodiment, the coating layer may include Co, Al, Nb, Ti, B, or a combination thereof.

The positive electrode active material according to the present disclosure may have a D₅₀ ranging from about 2.0 μm to 20.0 μm, for example, from about 2.0 μm to 15.0 μm, or from about 3.0 μm to 10.0 μm. When the D₅₀ of the positive electrode active material is within the above range, processability during electrode fabrication and electrolyte impregnation properties are excellent, resistance is reduced, and output characteristics are improved.

### Positive Electrode

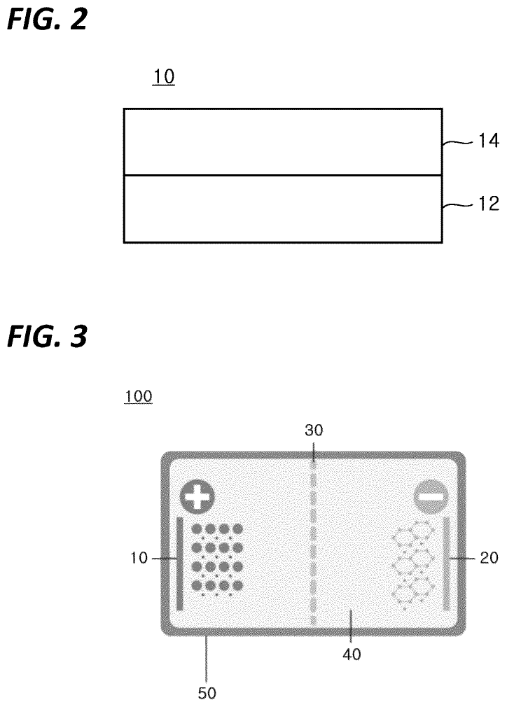

Next, referring to FIG. 2, the positive electrode according to the present disclosure will be described.

The positive electrode 10 according to the present disclosure includes the above-described positive electrode active material. For example, the positive electrode 10 according to an embodiment of the present disclosure may include a positive electrode current collector 12 and a positive electrode composite layer 14 including the above-described positive electrode active material.

As the positive electrode current collector 12, various positive electrode current collectors used in the relevant technical field may be used. For example, the positive electrode current collector 12 may include stainless steel, aluminum, nickel, titanium, calcined carbon, or a surface-treated material in which the surface of aluminum or stainless steel is treated with, for example, carbon, nickel, titanium, or silver. The positive electrode current collector 12 may typically have a thickness ranging from about 3 μm to 500 μm, and a fine uneven structure may be formed on the surface of the positive electrode current collector 12 to improve the adhesion of the positive electrode active material. The positive electrode current collector 12 may be used in various forms such as a film, a sheet, a foil, a net, a porous body, a foam, or a nonwoven fabric.

The positive electrode composite layer 14 may be disposed on the positive electrode current collector 12 and may be located, for example, on one surface or both surfaces of the positive electrode current collector 12. The positive electrode composite layer 14 may have a single-layer or multilayer structure of two or more layers.

The positive electrode composite layer 14 may include the positive electrode active material of the present disclosure, a positive electrode conductive agent, and a positive electrode binder.

In this case, since the positive electrode active material is the same as the positive electrode active material according to the present disclosure described above, further description thereof will be omitted.

According to an embodiment, the positive electrode active material may be included in an amount ranging from about 90 wt % to 99 wt %, for example, from about 92 wt % to 98 wt %, or from about 94 wt % to 98 wt %, based on the total weight of the positive electrode composite layer 14. When the above range is satisfied, the energy density and capacity characteristics of the lithium secondary battery to which the positive electrode is applied may be improved.

The positive electrode conductive agent is used to impart electrical conductivity to the electrode and may be used without particular limitation as long as it exhibits electronic conductivity without causing a chemical change in the battery in which it is used. Examples of the positive electrode conductive agent may include: graphite such as natural graphite or artificial graphite; carbon-based materials such as carbon black, acetylene black, Ketjen black, channel black, furnace black, lamp black, thermal black, carbon fiber, or carbon nanotubes; metal powders or metal fibers of, for example, copper, nickel, aluminum, or silver; conductive whiskers of, for example, zinc oxide or potassium titanate; conductive metal oxides such as titanium oxide; or conductive polymers such as polyphenylene derivatives, which may be used either alone or in combination thereof. The positive electrode conductive agent may be typically included in an amount ranging from about 0.1 wt % to 10 wt %, for example, from about 0.1 wt % to 8 wt %, or from about 0.1 wt % to 5 wt %, based on the total weight of the positive electrode composite layer.

The positive electrode binder serves to enhance adhesion between particles of the positive electrode material and between the positive electrode material and the positive electrode current collector. Examples of the positive electrode binder may include: fluororesin-based binders such as polyvinylidene fluoride (PVDF) or polytetrafluoroethylene (PTFE); rubber-based binders such as styrene-butadiene rubber (SBR), acrylonitrile-butadiene rubber, or styrene-isoprene rubber; cellulose-based binders such as carboxymethyl cellulose (CMC), starch, hydroxypropyl cellulose, or regenerated cellulose; polyalcohol-based binders such as polyvinyl alcohol; polyolefin-based binders such as polyethylene or polypropylene; polyimide-based binders; polyester-based binders; and silane-based binders, which may be used either alone or in combination thereof. The positive electrode binder may be included in an amount ranging from about 1 wt % to 10 wt %, for example, from about 0.5 wt % to 10 wt %, or from about 1 wt % to 8 wt %, based on the total weight of the positive electrode composite layer.

The positive electrode 10 may be produced by a method known in the relevant technical field. For example, the positive electrode 10 may be manufactured by preparing a positive electrode slurry by mixing a positive electrode active material, a positive electrode binder, and a positive electrode conductive agent in a solvent, coating the positive electrode slurry onto a positive electrode current collector, and drying and rolling the coated layer. Alternatively, the positive electrode 10 may be manufactured by casting the positive electrode slurry onto a separate support, peeling off the resulting film from the support, and laminating the film obtained thereby onto the positive electrode current collector. As the solvent of the positive electrode slurry, solvents generally used for positive electrode slurries in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto.

The solvent may be used in an amount sufficient to dissolve or disperse the positive electrode active material, the positive electrode conductive agent, and the positive electrode binder, and to provide a viscosity suitable for uniform coating of the positive electrode slurry.

### Lithium Secondary Battery

Next, referring to FIG. 3, a lithium secondary battery according to an embodiment of the present disclosure will be described. A lithium secondary battery 100 according to an embodiment of the present disclosure includes a positive electrode 10 according to the present disclosure, a negative electrode 20 disposed to face the positive electrode 10, a separator 30 interposed between the positive electrode 10 and the negative electrode 20, and an electrolyte 40. In addition, the lithium secondary battery 100 according to an embodiment of the present disclosure includes an electrode assembly formed of the positive electrode 10, the negative electrode 20, and the separator 30, and a battery case 50 that accommodates the electrode assembly and the electrolyte 40.

### (1) Positive Electrode

Since the positive electrode 10 is the same as described above, descriptions of the remaining components other than the positive electrode 10 will be provided below.

### (2) Negative Electrode

In the lithium secondary battery 100 according to the present disclosure, the negative electrode 20 may include a negative electrode composite layer including a negative electrode active material, and may include a negative electrode current collector and a negative electrode composite layer disposed on at least one surface of the negative electrode current collector.

The negative electrode current collector is not particularly limited as long as it has high conductivity and does not cause a chemical change in the battery. For example, copper, stainless steel, aluminum, nickel, titanium, calcined carbon, a material obtained by treating the surface of copper or stainless steel with carbon, nickel, titanium, or silver, or an aluminum-cadmium alloy may be used. In addition, the negative electrode current collector may typically have a thickness ranging from about 3 μm to 500 μm. Similarly to the positive electrode current collector, a fine uneven pattern may be formed on the surface of the current collector to enhance the adhesion strength of the negative electrode active material. For example, the negative electrode current collector may be used in various forms such as a film, a sheet, a foil, a net, a porous body, a foam, and a nonwoven fabric.

The negative electrode composite layer may be disposed on the negative electrode current collector, and may be located on one surface or both surfaces of the negative electrode current collector. The negative electrode composite layer may have a single-layer structure or a multilayer structure including two or more layers.

When the negative electrode composite layer has a multilayer structure including two or more layers, respective layers may differ from each other in terms of the type and/or content of the negative electrode active material, negative electrode binder, and/or negative electrode conductive agent. By forming the negative electrode composite layer as a multilayer structure and making the compositions of respective layers differ from each other, the performance characteristics of the battery, such as rapid charging performance and output characteristics, may be appropriately adjusted.

Meanwhile, as the negative electrode active material, a compound capable of reversibly intercalating and deintercalating lithium may be used. Examples of the negative electrode active material may include: carbon-based materials such as artificial graphite, natural graphite, graphitized carbon fiber, and amorphous carbon; metallic compounds capable of alloying with lithium, such as Si, Al, Sn, Pb, Zn, Bi, In, Mg, Ga, Cd, Si alloys, Sn alloys, or Al alloys; metal oxides capable of lithium doping and dedoping, such as SiO_{β}(0<β<2), SnO₂, vanadium oxides, and lithium vanadium oxides; or composites including the above-described metallic compounds and carbon-based materials, such as Si—C composites or Sn—C composites, which may be used either alone or in combination thereof.

Meanwhile, as the carbon-based material, both low-crystallinity carbon and high-crystallinity carbon may be used. Soft carbon or hard carbon are representative examples of low-crystallinity carbon, and high-temperature-calcined carbon, such as amorphous carbon, plate-shaped, flake-shaped, spherical, or fibrous natural graphite or artificial graphite, kish graphite, pyrolytic carbon, mesophase pitch-based carbon fiber, meso-carbon microbeads, mesophase pitches, and petroleum or coal tar pitch-derived cokes, is a representative example of high-crystallinity carbon.

According to an embodiment, the negative electrode active material may be a carbon-based negative electrode active material. In this case, the carbon-based negative electrode active material may include, for example, natural graphite, artificial graphite, graphitized carbon fiber, amorphous carbon, soft carbon, hard carbon, or a combination thereof. Alternatively, the carbon-based negative electrode active material may include natural graphite and artificial graphite.

The carbon-based negative electrode active material may have an average particle diameter (D₅₀) ranging from about 2 μm to 30 μm, for example, from about 5 μm to 30 μm.

The negative electrode active material may be included in an amount ranging from about 80 wt % to 98 wt %, from about 90 wt % to 98 wt %, or from about 93 wt % to 98 wt %, based on the total weight of the negative electrode composite layer. When the content of the negative electrode active material satisfies the above range, excellent energy density may be achieved.

The negative electrode composite layer may further include a negative electrode conductive agent and/or a negative electrode binder together with the negative electrode active material.

The negative electrode conductive agent is used to impart electrical conductivity to the negative electrode and may be used without particular limitation as long as it exhibits electronic conductivity without causing a chemical change in the battery.

Examples of the negative electrode conductive agent may include: carbon-based materials such as carbon black, acetylene black, Ketjen black, channel black, furnace black, lamp black, thermal black, carbon fiber, and carbon nanotubes; metal powders or metal fibers of, for example, copper, nickel, aluminum, or silver; conductive whiskers of, for example, zinc oxide or potassium titanate; conductive metal oxides such as titanium oxide; and conductive polymers such as polyphenylene derivatives, which may be used either alone or in combination thereof.

The negative electrode conductive agent may typically be included in an amount ranging from about 0.1 wt % to 10 wt %, from about 0.1 wt % to 8 wt %, or from about 0.1 wt % to 5 wt %, based on the total weight of the negative electrode composite layer.

The negative electrode binder serves to enhance adhesion between negative electrode active material particles and between the negative electrode active material and the negative electrode current collector. Examples the negative electrode binder may include: polyvinylidene fluoride (PVDF); vinylidene fluoride-hexafluoropropylene copolymer (PVDF-co-HFP); polyvinyl alcohol; polyacrylonitrile; carboxymethyl cellulose (CMC); starch; hydroxypropyl cellulose; regenerated cellulose; polyvinylpyrrolidone; polytetrafluoroethylene; polyethylene; polypropylene; ethylene-propylene-diene monomer rubber (EPDM rubber); sulfonated EPDM; styrene-butadiene rubber (SBR); fluororubber; or various copolymers thereof, which may be used either alone or in combination thereof.

The negative electrode binder may be included in an amount ranging from about 0.1 wt % to 10 wt %, from about 0.5 wt % to 10 wt %, or from about 1 wt % to 8 wt %, based on the total weight of the negative electrode composite layer.

The negative electrode 20 may be produced by a method known in the relevant technical field. For example, the negative electrode 20 may be produced by preparing a negative electrode slurry by mixing a negative electrode active material, a negative electrode binder, and a negative electrode conductive agent in a solvent, coating the negative electrode slurry onto a negative electrode current collector, and drying and rolling the coated layer. Alternatively, the negative electrode 20 may be produced by casting the negative electrode slurry onto a separate support, peeling off the resulting film from the support, and laminating the film obtained thereby onto the negative electrode current collector.

As the solvent of the negative electrode slurry, solvents generally used in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto. The solvent may be used in an amount sufficient to dissolve or disperse the negative electrode active material, the negative electrode conductive agent, and the negative electrode binder, and to provide a viscosity suitable for uniform coating of the negative electrode slurry.

### (3) Separator

The separator (30) physically separates a negative electrode and a positive electrode and provides a path for lithium-ion migration, and any separator commonly used in lithium secondary batteries may be used without particular limitation. In this case, the separator (30) may be interposed between the positive electrode (10) and the negative electrode (20).

According to an embodiment, a porous polymer film made of a polyolefin-based polymer, such as an ethylene homopolymer, a propylene homopolymer, an ethylene/butene copolymer, an ethylene/hexene copolymer, or an ethylene/methacrylate copolymer, or a laminated structure including two or more layers thereof, may be used. In addition, a conventional porous nonwoven fabric such as a nonwoven fabric made of, for example, high melting point glass fiber or polyethylene terephthalate fiber may be used. In addition, a coated separator containing a ceramic component or a polymer material to ensure heat resistance or mechanical strength may be used, and may optionally be used in a single-layer or multi-layer structure.

### (4) Electrolyte

The electrolyte 40 according to the present disclosure may include a lithium salt and an organic solvent.

The lithium salt may be used without particular limitation as long as it is a compound capable of providing lithium ions used in a lithium secondary battery 100. Examples of the lithium salt include LiPF₆, LiClO₄, LiAsF₆, LiBF₄, LiSbF₆, LiAlO₄, LiAlCl₄, LiCF₃SO₃, LiC₄F₉SO₃, LiN(C₂FsSO₃)₂, LiN(C₂FsSO₂)₂, LiN(CF₃SO₂)₂, LiCl, LiI, or LiB(C₂O₄)₂. According to an embodiment, the concentration of the lithium salt may be used within a range from about 0.1 M to 5.0 M, or from about 0.1 M to 3.0 M. When the concentration of lithium salt is within the above-mentioned ranges, the electrolyte has appropriate conductivity and viscosity, so that excellent electrolyte performance can be achieved and lithium ions can effectively move.

The organic solvent may include at least one selected from cyclic carbonate-based organic solvents, linear carbonate-based organic solvents, linear ester-based organic solvents, and cyclic ester-based organic solvents.

The cyclic carbonate-based organic solvent is a high-viscosity organic solvent, and may include, as a representative example, at least one organic solvent selected from ethylene carbonate (EC), propylene carbonate (PC), 1,2-butylene carbonate, 2,3-butylene carbonate, 1,2-pentylene carbonate, 2,3-pentylene carbonate, and vinylene carbonate.

In addition, the linear carbonate-based organic solvent is a low-viscosity and low-dielectric-constant organic solvent, and the representative examples thereof may include at least one organic solvent selected from dimethyl carbonate (DMC), diethyl carbonate (DEC), dipropyl carbonate, ethyl methyl carbonate (EMC), methyl propyl carbonate, and ethyl propyl carbonate, and according to an embodiment, may include ethyl methyl carbonate (EMC).

The linear ester-based organic solvent may include at least one organic solvent selected from methyl acetate, ethyl acetate, propyl acetate, methyl propionate, ethyl propionate, propyl propionate, and butyl propionate.

The cyclic ester-based organic solvent may include at least one organic solvent selected from butyrolactone, valerolactone, and caprolactone.

According to an embodiment, the electrolyte 40 according to the present disclosure may include ethylene carbonate and dimethyl carbonate as the organic solvent.

Meanwhile, the electrolyte 40 may further include other additives in addition to the above-described electrolyte components for the purposes of improving battery lifespan characteristics, suppressing capacity reduction, and enhancing discharge capacity.

Such other additives may include, as a represent example, at least one selected from cyclic carbonate compounds, halogen-substituted carbonate compounds, sulfone compounds, sulfate compounds, borate compounds, nitrile compounds, benzene compounds, amine compounds, silane compounds, and lithium salt compounds different from the lithium salt included in the electrolyte.

For example, the other additives may include one or more compounds selected from vinylene carbonate (VC), vinyl ethylene carbonate, fluoroethylene carbonate (FEC), 1,3-propane sultone (PS), 1,4-butane sultone, ethenesultone, 1,3-propene sultone (PRS), 1,4-butene sultone, 1-methyl-1,3-propene sultone, ethylene sulfate (Esa), trimethylene sulfate (TMS), methyl trimethylene sulfate (MTMS), tetraphenylborate, lithium oxalyldifluoroborate, succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, fluorobenzene, triethanolamine, ethylenediamine, tetravinylsilane, lithium bis(fluorosulfonyl)imide (LiFSI), lithium bis(trifluoromethane sulfonyl)imide (LiTFSI), LiPO₂F₂, LiODFB, lithium bis(oxalato)borate (LiB(C₂O₄)₂; LiBOB), and LiBF₄.

The other additives may be included in an amount ranging from about 0.01 wt % to 20 wt %, for example, from about 0.05 wt % to 5.0 wt %, based on the total weight of the electrolyte. The effect of improving low-temperature output of a battery and improving high-temperature storage characteristics and high-temperature lifetime characteristics is excellent at other additive contents within the above range, and side reactions in the electrolyte during charging and discharging of the battery may be appropriately suppressed.

### (5) Battery Case

A battery case 50 according to an embodiment of the present disclosure may be manufactured, depending on its manufactured shape, in a prismatic type, pouch type, coin type, or cylindrical type.

The lithium secondary battery 100 according to the present disclosure may be advantageously applied to portable devices such as mobile phones, laptop computers, and digital cameras, as well as to electric vehicle fields such as hybrid electric vehicles (HEVs). The lithium secondary battery 100 according to the present disclosure, which may exhibit excellent output characteristics even under low-temperature conditions, may be particularly useful in the field of electric vehicles.

According to another embodiment of the present disclosure, a battery module including the lithium secondary battery 100 according to the present disclosure as a unit cell and a battery pack including the same are provided.

The battery module or the battery pack may be used as a power source for one or more medium- or large-sized devices such as power tools, electric vehicles (EVs) including hybrid electric vehicles (HEVs) and plug-in hybrid electric vehicles (PHEVs), or power storage systems.

Hereinafter, the present disclosure will be described in more detail with reference to examples. However, the following examples are provided only to enable those skilled in the art to fully understand and easily implement the present disclosure, and the scope of the present disclosure is not limited to the following examples.

### Example 1

Lithium nitrate, nickel nitrate, cobalt nitrate, and manganese nitrate were dissolved in nitric acid in amounts such that the molar ratio of Li:Ni:Co:Mn was 1:0.6:0.1:0.3 to prepare a reaction mixture. In this case, the lithium-to-transition-metal molar ratio in the reaction mixture was 1:1.

The reaction mixture was introduced into a spray pyrolysis apparatus, sprayed into a high-temperature reactor at 400° C. under a pressure of 0.1 MPa, and pyrolyzed at a rate of 1.43 hours per ton. The precursor powder generated after completion of the pyrolysis was obtained.

The obtained precursor powder was primarily calcined at 860° C. for 4 hours and then calcined at 960° C. for 8 hours to prepare a positive electrode active material.

The positive electrode active material prepared as described above, a conductive agent (carbon black), and a PVdF binder were mixed in N-methyl-2-pyrrolidone at a weight ratio of 95:2:3 to prepare a positive electrode slurry. The positive electrode slurry was coated onto an aluminum current collector and dried and rolled to manufacture a positive electrode.

A porous polyethylene separator was interposed between the positive electrode and a lithium metal electrode (negative electrode) to manufacture an electrode assembly, and after inserting the electrode assembly into a battery case, an electrolyte was injected to manufacture a coin half-cell.

### Example 2

Except that lithium nitrate, nickel nitrate, cobalt nitrate, and manganese nitrate were dissolved in nitric acid in amounts such that the molar ratio of Li:Ni:Co:Mn was 1.02:0.6:0.1:0.3 to prepare a reaction mixture, precursor powder, a positive electrode active material, a positive electrode, and a coin half-cell were manufactured in the same manner as in Example 1. In this case, the lithium-to-transition-metal molar ratio in the reaction mixture was 1.02:1.

### Example 3

Except that lithium nitrate, nickel nitrate, cobalt nitrate, and manganese nitrate were dissolved in nitric acid in amounts such that the molar ratio of Li:Ni:Co:Mn was 1.06:0.6:0.1:0.3 to prepare a reaction mixture, precursor powder, a positive electrode active material, a positive electrode, and a coin half-cell were manufactured in the same manner as in Example 1. In this case, the lithium-to-transition-metal molar ratio in the reaction mixture was 1.06:1.

### Comparative Example 1

Except that lithium nitrate, nickel nitrate, cobalt nitrate, and manganese nitrate were dissolved in nitric acid in amounts such that the molar ratio of Li:Ni:Co:Mn was 0.98:0.6:0.1:0.3 to prepare a reaction mixture, precursor powder, a positive electrode active material, a positive electrode, and a coin half-cell were manufactured in the same manner as in Example 1. In this case, the lithium-to-transition-metal molar ratio in the reaction mixture was 0.98:1, which is outside the scope of the present disclosure.

### Comparative Example 2

Except that lithium nitrate, nickel nitrate, cobalt nitrate, and manganese nitrate were dissolved in nitric acid in amounts such that the molar ratio of Li:Ni:Co:Mn was 1.1:0.6:0.1:0.3 to prepare a reaction mixture, precursor powder, a positive electrode active material, a positive electrode, and a coin half-cell were manufactured in the same manner as in Example 1. In this case, the lithium-to-transition-metal molar ratio in the reaction mixture was 1.1:1, which is outside the scope of the present disclosure.

### Experimental Example 1

Precursor powders prepared in Examples 1 to 3 and Comparative Examples 1 and 2 were loaded into a powder holder of an XRD device (Bruker D8 Endeavor-2) such that the sample surfaces became uniform, and X-ray diffraction analysis was performed under the conditions below to obtain XRD spectra.

From the XRD spectra, a ratio A_{Li}_{₂}_{CO}_{₃}/Aₜₒₜₐₗ, which is a ratio of a sum of areas of peaks representing Li₂CO₃ (A_{Li}_{₂}_{CO}_{₃}) to a sum of areas of all peaks (Aₜₒₜₐₗ), was obtained.

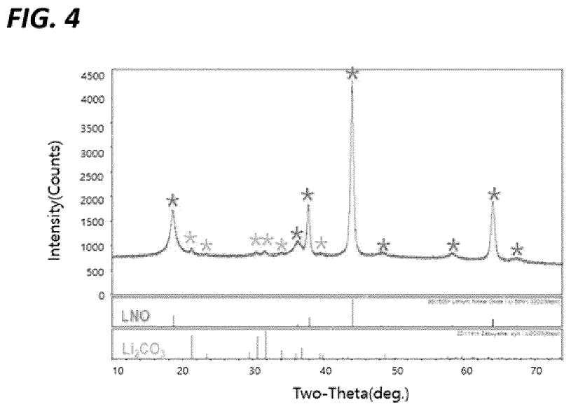

The measurement results are shown in Table 1 below. FIG. 4 illustrates an XRD spectrum of a precursor for a positive electrode active material prepared by the method of Example 2.

### <XRD Measurement Conditions>

X-ray: Cu Ka 40 kV, 40 mA
Measurement range (2θ): 100 to 700
Step increment (2θ): 0.040
Measurement time (time/step): 0.5 sec

Meanwhile, referring to FIG. 4, peaks representing Li₂CO₃ were peaks appearing in regions where 2-theta (θ) was about 21.3°, 23.5°, 30.4°, 31.7°, 34.0°, and 39.8°.

### Experimental Example 2: Low-Temperature Resistance Measurement

Each coin half-cell prepared in Examples 1 to 3 and Comparative Examples 1 and 2 was charged to a state of charge (SOC) of 20, activated, and then charged again to SOC of 2. Thereafter, each charged battery was placed in a low-temperature (−10° C.) chamber and left standing for 3 hours. Then, while discharging continuously for 18 seconds at a constant current of 2 C, a voltage drop at low temperature was measured. The resistance (R=ΔV/I) was calculated by dividing the voltage drop amount (ΔV) occurring during 0 to 18 seconds by the current value (I). The measurement results are shown in Table 1 below.

### Experimental Example 3: Initial Capacity Measurement

After activating (formation) each coin half-cell prepared in Examples 1 to 3 and Comparative Examples 1 and 2, each battery was charged at 25° C. with a constant current of 0.1 C until the voltage reached 4.45 V, and then discharged with a constant current of 0.1 C until the voltage reached 2.5 V, and charging capacity and discharging capacity were measured.

### Experimental Example 4: Gas Generation Amount Measurement

An electrode assembly was manufactured by interposing a separator between each of the positive electrodes and each of the negative electrodes prepared in Examples 1 to 3 and Comparative Examples 1 and 2, and a lithium secondary battery was manufactured by placing the electrode assembly in a battery case and then injecting an electrolyte.

At this time, a negative electrode slurry was prepared by introducing a negative electrode active material, a negative electrode conductive agent, and a negative electrode binder into water at a weight ratio of 95.6:1:3.4. At this time, as the negative electrode active material, artificial graphite and natural graphite mixed at a weight ratio of 5:5 were used, carbon black was used as the negative electrode conductive agent, and styrene-butadiene rubber (SBR) and carboxymethyl cellulose (CMC) mixed at a weight ratio of 1.1:2.3 were used as the negative electrode binder. Thereafter, the negative electrode slurry was applied onto a copper current collector and then dried and rolled.

After storing the lithium secondary battery at 60° C. for 4 weeks, a gas generation amount (unit: mL) was measured. The gas generation amount was calculated by measuring (a weight in air)−(a weight in water) of the lithium secondary battery before and after storage and calculating the change in the above (a weight in air)−(a weight in water) before and after storage. The measurement results are shown in Table 1 below.

TABLE 1

| | | Law- | | | | |
|---|---|---|---|---|---|---|
| | | temperature | Charge | Discharge | Initial | Gas |
| | | resistance | capacity | capacity | efficiency | generation |
| | A_{Li2CO3}/Aₜₒₜₐₗ | [Ω] | [mAh/g] | [mAh/g] | [%] | amount |
| Example 1 | 0.01 | 171.2 | 220.8 | 200.7 | 90.9 | 0.28 |
| Example 2 | 0.03 | 162.6 | 221.5 | 202.1 | 91.2 | 0.3 |
| Example 3 | 0.1 | 162.2 | 221.2 | 201.9 | 91.3 | 0.32 |
| Comparative | 0 | 220.6 | 220.9 | 197.6 | 89.5 | 0.13 |
| Example 1 | | | | | | |
| Comparative | 0.2 | 207.3 | 221.6 | 200.6 | 90.5 | 0.75 |
| Example 2 | | | | | | |

From Table 1, it can be seen that Examples 1 to 3, in which precursors satisfying the range of A_{Li}_{₂}_{CO}_{₃}/Aₜₒₜₐₗ of the present disclosure (0.01-0.15) were applied, exhibited superior effects in terms of low-temperature resistance, initial efficiency, and gas generation amount, compared with Comparative Examples 1 and 2, in which precursors having A_{Li}_{₂}_{CO}_{₃}/Aₜₒₜₐₗ values outside the range of the present disclosure were applied. For example, in the case of low-temperature resistance, Examples 1, 2, and 3 showed relatively low values of 171.2 Ω, 162.6Ω, and 162.2Ω, respectively, whereas Comparative Examples 1 and 2 showed higher values of 220.6Ω and 207.3Ω, respectively, compared with the Examples.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A precursor for a positive electrode active material having a composition represented by Formula 1 below,
wherein a ratio (A_{Li2CO3}/Aₜₒₜₐₗ) of a sum of areas of peaks representing Li₂CO₃ (A_{Li2CO3}) to a sum of areas of all peaks (Aₜₒₜₐₗ) in an XRD spectrum obtained by performing X-ray diffraction analysis on the precursor ranges from about 0.01 to 0.15. 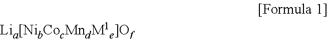
wherein, M¹ includes one or more elements selected from Al, Zr, Y, W, Nb, Ti, Ba, and Sr, and a, b, c, d, e, and f satisfy 1<a≤1.08, 0.5≤b<1, 0<c<0.5, 0<d<0.5, 0≤e≤0.2, and 2≤f≤2.06.

2. The precursor for a positive electrode active material according to claim 1, wherein the peaks representing Li₂CO₃ in the XRD spectrum appear in regions where 2-theta (0) values are about 21.3°, 23.5°, 30.4°, 31.7°, 34.0°, and 39.8°.

3. The precursor for a positive electrode active material according to claim 1, wherein, in Formula 1, a, b, c, and d satisfy 1.02≤a≤1.06, 0.5≤b≤0.8, 0.05≤c<0.5, and 05≤d<0.5.

4. The precursor for a positive electrode active material according to claim 1, wherein the precursor is in a form of secondary particles in which a plurality of primary particles are agglomerated, and
the primary particles have a polycrystalline structure.

5. The precursor for a positive electrode active material according to claim 1, wherein the precursor has a hollow structure.

6. The precursor for a positive electrode active material according to claim 1, wherein the precursor is produced by spray pyrolysis.

7. A method for producing a precursor for a positive electrode active material, the method comprising:
forming a reaction mixture by mixing a lithium source, a nickel source, a cobalt source, a manganese source, and a solvent; and
spraying the reaction mixture into a high-temperature reactor followed by pyrolysis to form the precursor for a positive electrode active material,
wherein a molar ratio of lithium to transition metal in the reaction mixture is about 1:1 to 1.08:1.

8. The method according to claim 7, wherein the lithium source is lithium metal, lithium carbonate, lithium hydroxide, lithium acetate, lithium oxalate, lithium sulfate, lithium chloride, lithium nitrate, or a combination thereof.

9. The method according to claim 7, wherein the nickel source is nickel metal, nickel carbonate, nickel hydroxide, nickel acetate, nickel sulfate, nickel chloride, nickel nitrate, nickel pig iron (NPI), mixed hydroxide precipitate (Ni HIP), or a combination thereof.

10. The method according to claim 7, wherein the cobalt source is cobalt metal, cobalt carbonate, cobalt hydroxide, cobalt acetate, cobalt sulfate, cobalt chloride, cobalt nitrate, mixed hydroxide precipitate (Co MHP), or a combination thereof.

11. The method according to claim 7, wherein the manganese source is manganese metal, aluminum metal, manganese carbonate, manganese hydroxide, manganese acetate, manganese sulfate, manganese chloride, manganese nitrate, mixed hydroxide precipitate (Mn MHP), or a combination thereof.

12. The method according to claim 7, wherein the solvent is sulfuric acid, nitric acid, acetic acid, carbonic acid, or a combination thereof.

13. The method according to claim 7, wherein the pyrolysis is performed at a temperature ranging from about 600° C. to 900° C.

14. A positive electrode active material comprising a calcined body of the precursor for a positive electrode active material according to claim 1.

15. The positive electrode active material according to claim 14, wherein the positive electrode active material includes a lithium-nickel-based oxide having a composition represented by Formula 2: 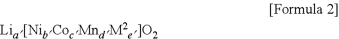
wherein, M² includes one or more elements selected from Al, Zr, Y, W, Nb, Ti, Ba, and Sr, and a′, b′, c′, d′, and e′ satisfy 0.8≤a′≤1.08, 0.5≤b′<1, 0<c′<0.5, 0<d′ <0.5, and 0≤e′≤0.2.

16. The positive electrode active material according to claim 15, wherein the positive electrode active material includes a single-particle-type lithium-nickel-based oxide including 50 nodules or fewer.

17. A positive electrode comprising the positive electrode active material according to claim 15.

18. A lithium secondary battery comprising the positive electrode according to claim 17, a negative electrode, a separator, and an electrolyte.
